(19) United States
(12) Patent Application Publication
(10) Pub. No.: US 2005/0164562 A1
(43) Pub. Date: Jul. 28, 2005

(54) Keying system for inter-mating connectors

(76) Inventors: William H. Lee, Petaluma, CA (US); Peter U. Mueller, Santa Rosa, CA (US); Joachim Vobis, Santa Rosa, CA (US)

Correspondence Address: MOSER, PATTERSON & SHERIDAN, L.L.P., 3040 POST OAK BOULEVARD, SUITE 1500, HOUSTON, TX, 77056, US

(21) Appl. No.: 10/838,550

(22) Filed: May 3, 2004

Related U.S. Application Data
(60) Provisional application No. 60/540,077, filed on Jan. 28, 2004.

(51) Int. Cl. H01R 13/648

(52) U.S. Cl. 439/680

(57) ABSTRACT

A system is provided for mechanically keying a number of cable connectors using a binary coding system to assure within a given set of cables that only one, unique matching set is defined. Binary keying is provided using 2×n holes aligned on each face of opposing key mounting surfaces, the holes aligned such that when a post is secured in a hole on one of such mounting surfaces, it will be received by a matching hole in the opposing mounting surface, provided said opposing mounting surface has been complimentarily keyed. The holes are arranged as bit pairs whereby each hole of the bit pair is assigned as the “0” and “1” position, the bit designated as either “0” or “1” depending into which of the paired holes a keying post is placed. By this system up to 2ⁿ uniquely keyed combinations can be provided.

### CROSS-REFERENCE TO RELATED APPLICATIONS

This application claims benefit of U.S. provisional patent application Ser. No. 60/540,077, filed Jan. 28, 2004, which is herein incorporated by reference.

### BACKGROUND OF THE INVENTION

1. Field of the Invention

Embodiments of the present invention generally relate to electrical, optical, fluidic and pneumatic type systems which can often have similar cable connectors mounted adjacent to each other. Such applications typically arise in a factory, or power plant environment, where numerous, identical components may be operated from one or more banks of control panels, and though the connections may appear identical, each cable is dedicated to carrying information between the control panel and a particular piece of equipment. For example, in a power plant setting, there may be a series of similar, functional units operating in series, each unit including an inlet and outlet pump, the pumps identical one to the other, and controlled through a common panel. In such case, it is imperative that the proper cable be connected to its assigned receptacle on the control panel.

In other applications, a multiplicity of components may be connected to the same control panel, wherein the electrical connectors employed may have similar looking or even identically looking shells but contain different numbers of contacts, in some cases as many as 100 or more, or may have the same number of contacts arranged in different patterns. In order to prevent damage (among other things) to the connector pins, it is likewise important that no attempt be made to couple the connector to other than its matching socket. In still other applications, such as nuclear installations, where the need to make connections may occur in radioactive environments, such is normally done remotely with the aid of robots. In this setting, where the operator acts from a distance, and is not able to easily inspect each connector to assure it is mated with the appropriate receptacle, mismatching becomes a serious issue. In such an application, a fail safe system is needed.

To eliminate the possibility of making an incorrect connection, especially where safety is a concern, it is common practice to incorporate mechanical keying systems. Typically such a mechanical keying system is manufactured as an integral connector component. Keying systems have for example been employed by companies like LEMO Corporation, for example as a feature of their B, K and F connector series. Where typically such systems have been provided, the number of keys typically has been limited to around 5. As the number of special connections using identical looking cable-connector combinations within a given application becomes larger, such as up to 20 to 30 or more, the task of manufacturing such unique connector mating pairs becomes particularly challenging. Furthermore, it becomes necessary to maintain a large number of spare parts in the event of a failure or damage.

Accordingly, a new keying system for inter-mating connectors has been created to address this need.

### SUMMARY OF THE INVENTION

A connector keying system is provided which can be quickly and simply configured to either allow or prevent connection for a multiplicity of similar connectors. The connector keying system comprises a key mounting surface disposed on each connector with multiple mounting holes sized to accept a plurality of individual keys. The user can define a key configuration by placement of the keys into the various mounting holes provided.

Both connectors in an intermating set utilize the same key mounting system. If any one key is located opposite another for a given connector mating pair, engagement of the connectors is prevented by the interference of the keys. If the keys are displaced one from the other so that they do not come into contact, engagement is allowed.

The system includes a plurality of key mounting surfaces which can be integral with or attached to the connector housing. The key are designed to be removably securable into key mounts, which key mounts among other options can be holes with internal threads or adopted for use with set screws. By way of example, but without being limited thereby, the keys can be provided with complimentary threaded posts for screwing into threaded key mounts, or smooth stemmed posts for set screw mounting. The height of the keys is determined by the length of engagement required for the given connectors, so as to prevent mating when opposing keys come into contact.

To assure uniqueness of the paired combinations, a keying method is employed based on the binary system. By way of this method, paired key mounts are provided on the key mounting surfaces, each pair representing a single bit, with each hole of a given pair designated as either the “0” or “1” position. The binary assignment of a given bit as either a “0” or “1” is determined when a key is placed into one or the other of the two paired holes. The number of paired holes provided will determine the number of unique combinations possible. For example, for a 4 bit system 16 combinations are possible, for a 5 bit system 32 combinations are possible, and for a 6 bit system, 64 combinations are possible. If a greater number of combinations are required, more bits can be employed. In keying individual connectors/sockets, a desired decimal number is initially selected for a first connector, and the complementary decimal number then selected for the receptacle. With the bit layout of the one connector the mirror image of the other, individual keys are inserted at the proper bit locations in each of the opposing key mounting faces, either into the “0” or “1” designated hole at a given bit location, until the binary equivalent of the selected key configuration has been keyed.

As an advantage of this approach, a fail safe combination of connections is assured using a minimum number of separate parts. Thus, for a given environment where, for example, 30 separate cabled connectors may be required, and thus a 5 bit key system called for, only one cable connector key mounting layout is required in addition to the requisite number of keys needed to code each of the opposing key mounting surfaces. In this way, by simplifying the parts requirement, manufacturing is simplified, and greater flexibility is afforded in the use of cables, i.e. any one like cable can be used in place of another once it has been properly keyed. Furthermore, because of the commonality of parts, fewer spares are required to be kept in inventory.

The invention will now be more fully explained below with reference to the following figures and detailed description. It is to be appreciated that the invention covers both the hardware used to key the connectors, and the system for coding them.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of a pair of mating connectors with the key posts mounted opposite each other to prevent coupling.

FIG. 2 is an illustration of the same pair of mating connectors wherein a single pair of key posts are positioned in interfering relationship, likewise preventing coupling.

FIG. 3 is an illustration of the same pair of mating connectors wherein the key posts are positioned in complimentary relationship so that the pins on the one key mounting surface are received by the holes associated with the other key mounting surface, thereby allowing the connectors to be coupled.

FIG. 4 is an illustration of the mating connectors of FIG. 3 in which the connectors have been decoupled to expose the positioning of the various key posts mounted to the plurality of paired mounting holes, each pair of holes representing a binary bit.

FIG. 5 is a binary keying chart showing the required keyed position of each post for a desired key configuration, the arrangements of FIGS. 4, 6 and 7 highlighted on the chart.

FIGS. 6 and 7 are illustrations of the connectors of FIG. 4 in which the keyed pins have been set in other complimentary arrangements.

FIG. 8 illustrates another embodiment of the invention for a 6 bit system, employing a second type of key design, in which the keys have been mounted in opposing position.

FIG. 9 depicts the assembly of FIG. 8 in which the connectors have been brought together in face to face relationship, coupling prevented as a result of the interference of the opposed pins.

FIG. 10 illustrates the assembly of FIG. 8, in which the keys on the one connector have be move to a complementary position to permit engagement.

### DETAILED DESCRIPTION OF THE PREFERRED EMBODIMENT

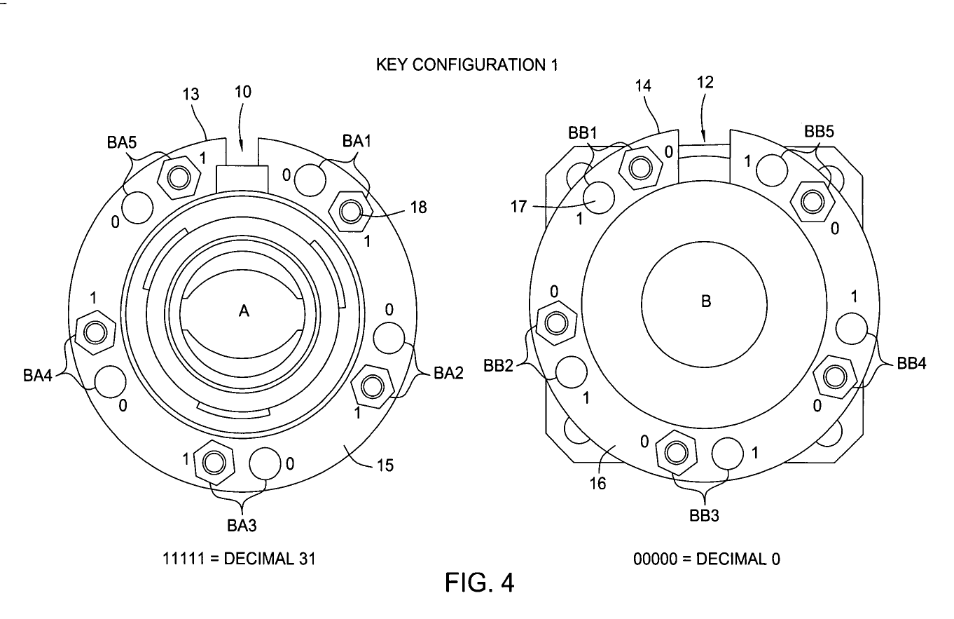

Typically, cable-to-cable or cable-to-panel connectors are brought together by press fit; oftentimes relying on engagement means to properly align the one connector with the other in the process of bringing them together. In the assembly shown in FIG. 4, such an alignment means is illustrated, which includes an engagement pin 10 mounted on a connector coupling A, the engagement pin sized to be accepted by a receiving slot 12 provided on a connector coupling B. The pin and slot must first be aligned before coupling is possible.

In the embodiment illustrated in the figure, the connectors are provided with collars 13 and 14, which can be the same or of different thickness, each collar, having a mounting surface 15 and 16, and provided with a number of mounting holes 17 dispersed peripherally around the connector body. For each hole disposed within the mounting surface 15 of collar 13, a matching, aligned hole is provided on the complimentary mounting surface 16 of collar 14.

It should be understood that the mounting holes need not necessarily be mounted on a collar as illustrated in the figures. In applications where the connector may have a non-circular cross section, the mounting collar or surface provided will be conformal to the perimeter housing. In other applications, mounting holes may be placed on opposing bars, or grids. Furthermore, the placement of the mounting surfaces need not be limited to the outside of the connector housing, as illustrated. If space permits, it may be mounted to the inside wall of the connector housing, or at other locations within or exterior to the said connector housing.

Referring back to FIG. 4, the assembly shown has 5 pairs of spaced holes associated with each connector. Each pair of spaced holes designates a binary bit, the bits labeled as BA1-BA5 on connector A and BB1-BB5 on connector B. Also shown are keys 18 mounted in select holes on connector A, and similar keys 18 mounted in complimentary holes on connector B. For a bit on connector A designated as a “1”, the complimentary bit on connector B will be a “0”, and vice versa. The placement of a key into one of the paired holes of each bit location determines whether a given bit is to be read as a zero, or as a one. In the 5 bit, 32 configuration binary keying system of the invention, connector A is shown key coded to binary numeral 31. Bit 5 of connector A, is keyed is in the “1” position; with bit 5 of connector B keyed to the complementary “0” or engaging position. Similarly, bit 4 of connector A is keyed in the “1” position, with bit 4 of connector B keyed to the complementary or mating “0” position. So keyed, when brought together the keys on the one face will not conflict with keys mounted to the holes of the other face, permitting coupling of the connectors. This same process is followed in keying each of the available bits, until all bits on each face have been keyed. In this configuration, the mating connectors will engage, as shown in FIG. 3.

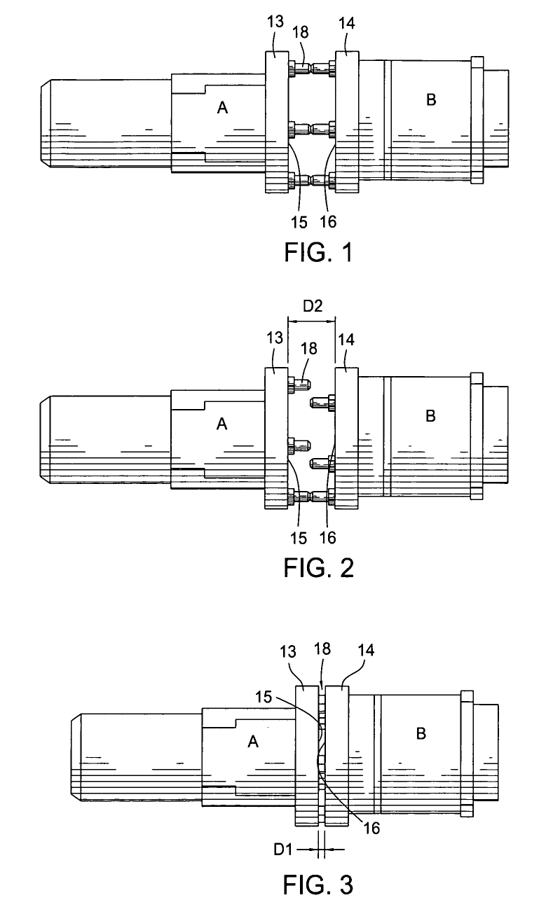

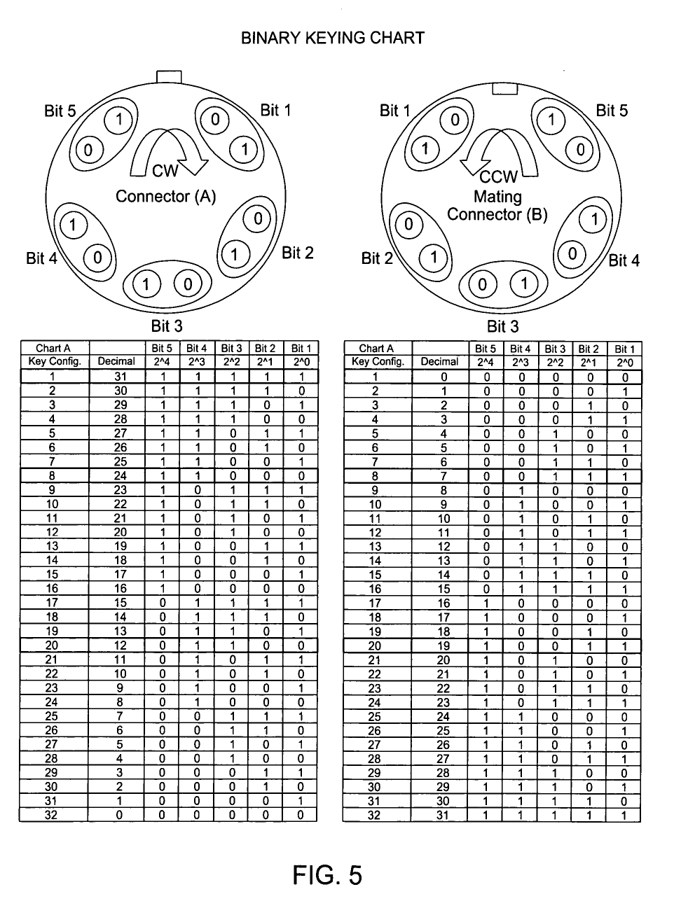

With reference to FIG. 1, mating connectors are illustrated in an uncoupled or opposing position, with each of the collar mounted keys abutting each other to prevent engagement. Even if only one key is out of position, such as shown in FIG. 2, the single pair of abutting keys will come into opposing relationship with each other to prevent connector mating. As can be seen from the Keying Chart, FIG. 5, for key configuration 1 (decimal 31—connector A, decimal 0—connector B), any other BB combination other than decimal 0, whereby at least one key of one bit is positioned in the “1” position, will prevent coupling, that key in conflict with, and making contact with one of the BA keys. Thus there is only one unique mating combination, that is where BB1-BB5 are coded to decimal zero.

The keys themselves may comprise a post or head having a threaded stem, the stem sized to be received into holes 17, which can be internally threaded to engage the threaded stems. In another embodiment, the stem may be smooth and held in place by set screws. In one embodiment, the heads of the keys may be slotted or otherwise modified to that they can be tightened using a screwdriver, allen wrench, or the like. In the illustrated embodiments, the head of each key is defined by a hexagonal nut, the head having a threaded lower portion or stem for engagement into threaded holes 17, and an extended upper portion or post sized to be received by a complimentary hole positioned on the opposite key mounting surface. In this embodiment the keys can be tightened in place using a properly sized tool such as a pair of pliers or wrench.

The height of the key posts of FIGS. 1-4, 6 and 7 is determined by the distance between the opposing faces 15 and 16 of the connecter collars 13 and 14 and the extent of travel required to fully engage and/or prevent engagement of the connectors. In the illustrated embodiment, the upper portion or post of the keys is sized so as to be fully received by the key holes of the opposing connector when the mating connectors are properly engaged. In one alternative, the key holes can be drilled completely through the collars, permitting the use of longer posts, which may be desirable where the keys need to span a greater distance in order to prevent connector coupling. In another embodiment, where the required post height is less, the key holes can be provided as blind holes.

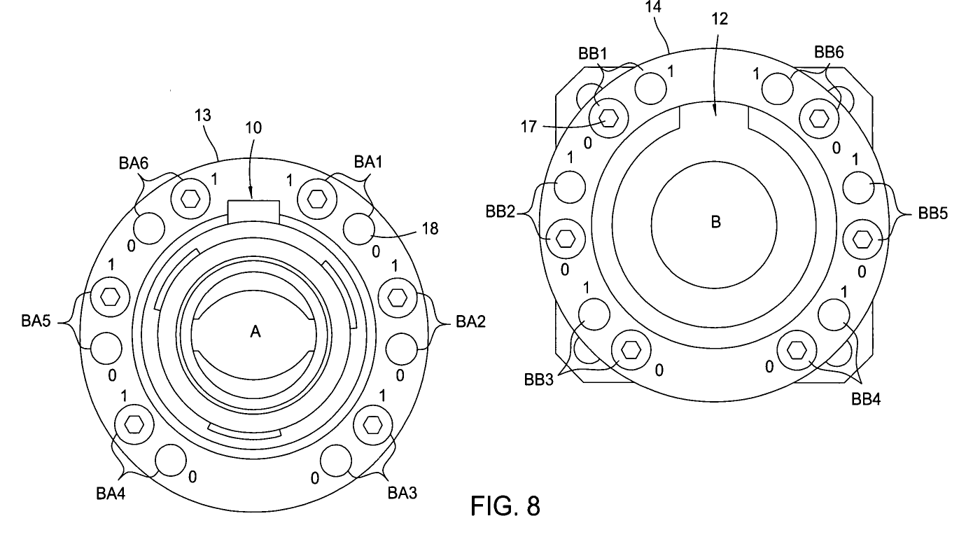

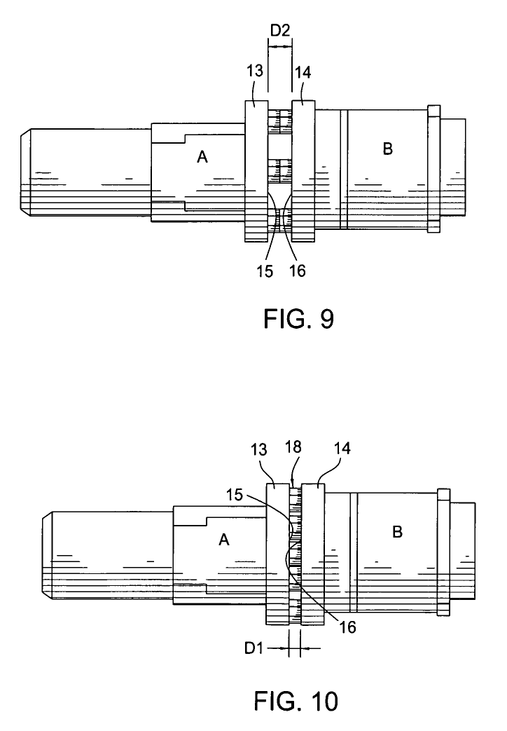

In the embodiment of FIGS. 8, 9 and 10 the keys though threaded do not include an extended upper portion. Here, the heads of the keys must be of sufficient dimension such that the spaced distance between the opposing mounting surfaces exceeds the required stand-off distance between the connectors to prevent engagement, as shown in FIG. 9. On the other hand, the height of the head of each key must be less than the distance between the opposing faces of the mounting surfaces, when all keys are in the complementary, engaged position to permit coupling, as shown in FIG. 10. The collars, shown integral with and circumferential to the outer shell of the connector, can be located anywhere along the longitudinal axis of the shell, the opposing faces defining a distance D1 between them when the connectors are mated. With the keys illustrated in FIGS. 1-4, 6 and 7, the thickness of the hexagonal nut must be less than distance D1 so as not to interfere with coupling when the keys are inserted and properly positioned. For the key alternative of FIGS. 8-10, the height of the head likewise will be of a dimension less than D1. With a minimum standoff distance D2 selected to define a non coupled state (D2>2×D1), distance D2 will further determine key dimension. That is, to assure the required separation D2 between the opposing mounting surfaces is provided, the keys, regardless of the type used, must define a distance greater than D2 when in opposing, i.e. abutting relationship.

In the binary embodiment of FIG. 4, in which a paired set of holes is used to define each bit, the keys are evenly distributed between the mounting surface of connector A and connector B. For a 5 bit, ten hole, 32 configuration binary key system, 5 keys are mounted on each connector collar. For a 6 bit, twelve hole, 64 configuration binary key system, 6 keys are mounted on each connector collar.

With reference again to the figures, the overall methodology of keying a series of connectors according to the invention will now be described for the 5 bit binary keying system illustrated, in which up to 2ⁿ (where n=5) number of exclusive connection configurations can be defined. In this system, each bit is represented by two mounting holes, one representing the open or “0” position, the other representing the closed or “1” position. Bit pairs are arranged sequentially in either a clockwise or counter clockwise direction around the face of the one mounting surface, with the bits on the other mounting surface arranged sequentially moving in the opposite direction (i.e. counter clockwise or clockwise, as the case may be). The “O” and “1” locations of each key for bits 1-5 are listed in the binary keying chart, FIG. 5, showing the keyed positions for both connectors A and B. By way of example and with reference to FIG. 5, for the first key configuration wherein connector A is assigned the binary equivalent of decimal number 31, the keys of each bit on connector A are placed in the “1” position, and the keys of connector B placed in the “0” position. Alternatively, for key configuration 32, connector A decimal 0, all five keys will be inserted into the “0” position, the keys of connector B inserted into the “1” position.

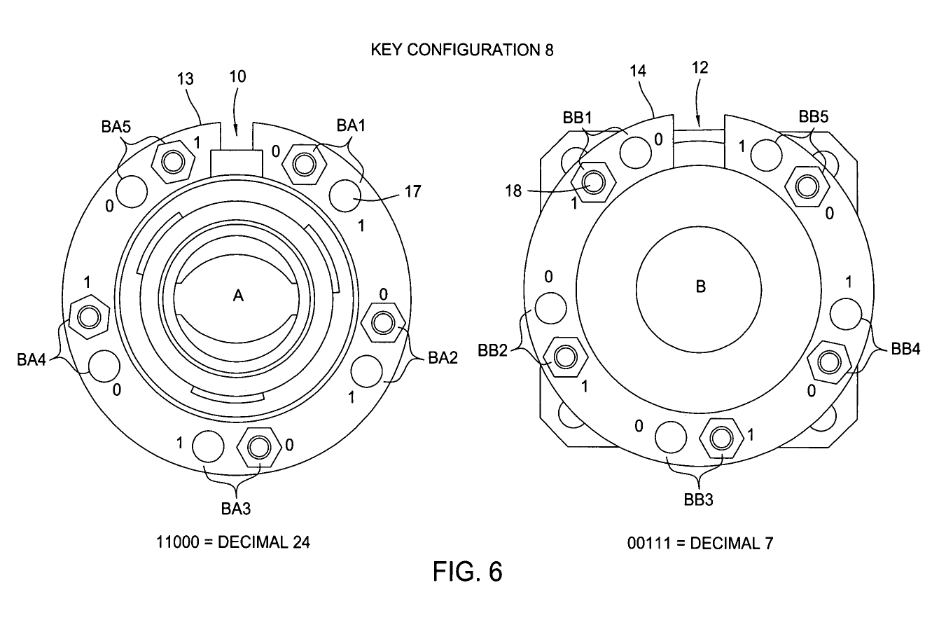

To properly key mating connector B, the 5 keys of that connector must be positioned in their complementary positions. With reference again to the illustrated embodiment of FIG. 4, the bits of mating connector B are arranged in mirror image to those of connector A, and read counter-clockwise, with the first mounting hole of the first bit pair defining the “0” position, the second mounting hole defining the “1” position, and so forth for each of the 5 bits. With each of these bit pairs, if the corresponding bit on connector A is in the “0” position, the key of the associated bit on connector B must be placed in the “1” position, and vice versa. For each of the possible combinations, Chart A of FIG. 5 provides the required keyed positions for a given configuration, the corresponding complementary keyed positions for connector B listed in Chart B. By way of illustration and with reference to the tables of FIG. 5, to achieve keyed configuration 8 (decimal 24—connector A and decimal 7—connector B) illustrated in FIG. 6, the required key settings for mating connectors A and B are:

| | Bit 5 | Bit 4 | Bit 3 | Bit 2 | Bit 1 |
|---|---|---|---|---|---|
| Connector A | 1 | 1 | 0 | 0 | 0 |
| (binary #24) | | | | | |
| Connector B | 0 | 0 | 1 | 1 | 1 |
| (binary #7) | | | | | |

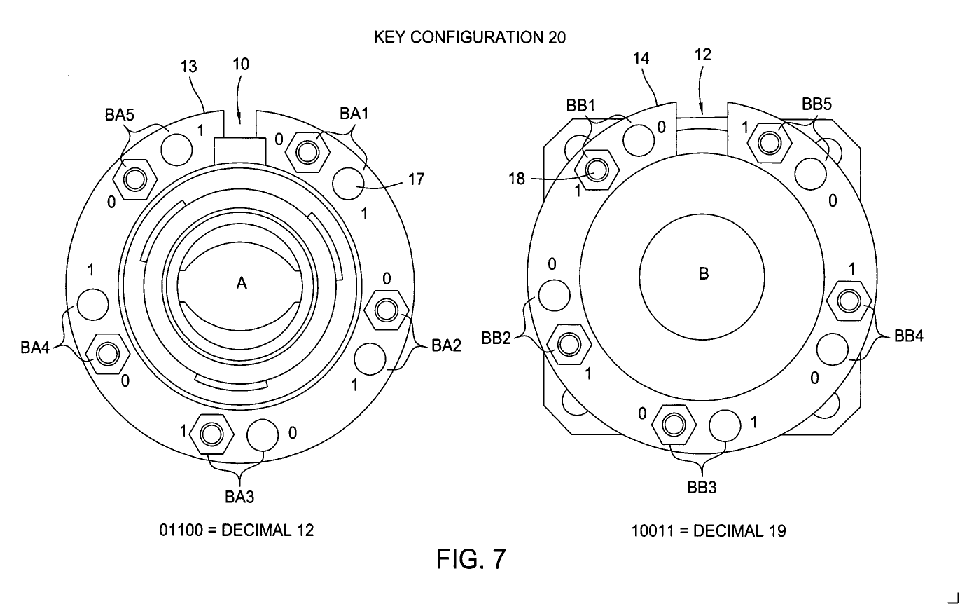

With keyed configuration 20 illustrated in FIG. 7 for decimal 12 (connector A) and decimal 19 (connector B), as highlighted in the chart, the keys are set to define binary number 01100 for connector A, and complimentary binary number 10011 for connector B. By following the chart, all 32 possible combinations can be coded, whereby only one, mating combination allows for coupling. A mismatch is not possible.

In the embodiment described, the mounting holes are clustered in pairs to visually aid in identification of the bit locations and placement of keys in the proper position. However, such pair clustering is not required. That is, the mounting holes may be uniformly spaced one from the other on the mounting surfaces. As an alternative means of identification, each bit can be specially marked or labeled to aid in key placement. Whether to cluster or mark the mounting holes is a matter of manufacturing choice, and in fact both options can be used alone or in combination.

Described above is an article of manufacture comprising a keying system for mating connectors. Also described has been a simple and systematic method for defining a set of unique keyed combinations. According to the binary keying method of this invention, any combination of exclusive connection options can be provided up to 2ⁿ, with n is a whole number equaling the number of bits provided, and 2×n being the number of mounting holes required to be placed on each key mounting surface. The mounting surfaces, such as provided by the collars illustrated can be custom configured based on a users needs to allow for any number of desired, unique mating connector combinations. Thus for a user requiring but 20 keyed configurations, the configurability of a 5 bit system will suffice. For a user needing 33 or more different keyed configurations, at least a 6 bit (12 mounting hole) system will be required.

In the embodiments depicted in the figures, electrical connectors have been shown by way of illustration. However, as previously noted, the keying system of this invention is not limited such connectors, but may be used with any type of connector system in which opposing parts are brought into engagement. Such types of connectors are commonly employed with optical, fluidic and pneumatic systems, and the keying methods of this invention are equally applicable for use with connectors of such systems.

Having thus described the invention it will be obvious to one of ordinary skill in the art that other key position mounting protocols may be followed, so long as they provide unique combinations, and that less than all the pin positions may be used, without departing from the spirit of this invention. While the foregoing is directed to embodiments of the present invention, other and further embodiments of the invention may be devised without departing from the basic scope thereof, and the scope thereof is determined by the claims that follow.

1. A intermating connector assembly incorporating a keying system, said assembly comprising:
a first connector having an outer shell;
a second, mating connector having an outer shell;
a mounting surface affixed to said first connector incorporating a number of mounting holes,
a mounting surface affixed to said second connector incorporating an equal number of mounting holes, the holes of said second connector positioned to align with those of said first connector with the two connectors in face to face alignment for engagement; and,
one or more keys removably secured to said mounting holes.

2. The intermating connector assembly of claim 1, further having an even number of mounting holes associated with each connector, wherein half the keys are mounted on the first connector, and half mounted on the second connector.

3. The intermating connector assembly of claim 1 wherein the mounting surfaces of each connector are defined by a mounting collar peripheral to the outer shell of the first and second intermating connectors.

4. The intermating connector assembly of claim 1 further including a locating pin mounted on one of said connectors, and a receiving slot mounted on the other of said connectors to receive said pin and align the first connector relative to the second connector for engagement.

5. The intermating connector assembly of claim 1 wherein the mounting holes are threaded, and said keys include a threaded stem.

6. The intermating connector assembly of claim 1 wherein each mounting hole is provided with a set screw, the keys including a smooth stem for engagement by said set screw.

7. The intermating connector assembly of claim 1 wherein said keys include a post which extends from the head of the key in a direction opposite from said stem, and sized such that when at least one key of either connector is mounted in opposition to a corresponding key on the other connector, the distance defined by the opposing keys is sufficient to prevent connector coupling.

8. The intermating connector assembly of claim 1 wherein at least one of said connectors is positioned at the end of a cable.

9. A binary method for keying one or more intermating connector pairs, said connectors including on a first connector a locator pin, and on a second connector a receiving slot for accepting said pin, wherein each connector has associated with it 2×n number of mounting holes, n being a whole number representing a predetermined number of individual binary bits, with each bit defined by a pair of mounting holes, said method including the steps of:
in a first direction in ascending order, assigning bit numbers to the mounting holes associated with said first connector;
in said first direction, using the same order for each paired set of mounting holes, designating the first hole of each pair as either the “0” or “1” position, the second hole as either the “1” or “0” position;
in a second direction opposite from said first direction, in ascending order, assigning bit numbers to the mounting holes associated with said second connector:
in said second direction, using the same order for each paired set of mounting holes, designating the first hole of each pair as either the “0” or “1” position, the second hole designated as either the “1” or “0” position, whereby when the first position of the mounting hole pair of the first connector is assigned the “0” position, the first position of the mounting hole pair of the second connector is assigned the “0” position, and when the first position of the mounting hole pair of the first connector is assigned the “1” position, the first position of the mounting hole pair of the second connector is assigned the “1” position;
providing n number of keys including mounting means for securing the keys into the mounting holes of the first connector, and n number of keys including mounting means for securing the keys into the mounting holes of the second connector;
selecting a decimal number between 0 and 2ⁿ, and inserting the provided keys into the appropriate hole of each of the paired holes associated with each bit of said first connector to define the binary equivalent of the selected number; and,
inserting the provided keys for the second connector into the complimentary holes for each associated bit pair of said second connector,
whereby a unique, keyed mating combination is defined.

10. The method of claim 9 wherein the first direction is clockwise and the second direction is counter clockwise.

11. The method of claim 10 wherein the locator pin of the first connector defines the 12 o'clock position for said first connector, and the receiving slot of the second connector defines the 12 o'clock position for said second connector.

12. The method of claim 9 wherein the first position of the mounting hole pair of the first connector is designated as the “0” position, the second mounting hole designated as the “1” position.

13. The method of claim 9 wherein n is equal to or greater than 5.

14. A cable including a connector at one end, said connector designed to mate with a second receiving connector, wherein said connector further includes:
a mounting surface affixed thereto, said surface incorporating 2×n mounting holes, wherein n is a whole number, said mounting holes arranged in pairs and sized to receive the stem of an inserted key;
n number of keys removably inserted into one or the other hole of each pair of said mounting holes; and,
means for securing said keys in place.
